(19) United States
(12) Patent Application Publication
(10) Pub. No.: US 2007/0264859 A1
(43) Pub. Date: Nov. 15, 2007

(54) Cord retention device

(76) Inventor: Lourdes Lopez Valle, Mahopac, NY (US)

Correspondence Address: STEVEN A. GARNER, ESQ.;CONAIR CORPORATION, ONE CUMMINGS POINT ROAD, STAMFORD, CT, 06902, US

(21) Appl. No.: 11/431,692

(22) Filed: May 10, 2006

(51) Int. Cl. H01R 13/62

(52) U.S. Cl. 439/369

(57) ABSTRACT

A device (10) for storing and retaining a cord (24) or cord-like article has a core (12) adapted to retain a cord (24) that is wound around it; a pair of flanges (14, 16) to maintain the cord (24) on the core (12); and a handle extension (18) for grasping the device (10).

### CROSS-REFERENCE TO RELATED APPLICATIONS

None.

### BACKGROUND OF THE INVENTION

1. Field of the Invention

The present invention relates to devices for handling cords including, but not limited to, power cords attached to electrical appliances.

2. Description of Related Art

Various known devices exist for winding up and storing cords such as power cords or simple rope. These known devices exist in many shapes, sizes and materials depending on intended use, cost parameters and other factors.

### OBJECTS OF THE PRESENT INVENTION

It is an object of the present invention to provide a versatile cord retaining device that may be used with electrical or non-electrical cords that is of simple, cost-efficient and durable design and construction.

These and other objects are achieved by the present invention.

### BRIEF SUMMARY OF THE PRESENT INVENTION

According to the present invention, a cord retaining device has a unitary body with a wound cord contact portion, a pair of flanges for containing a wound cord on the wound cord portion, and at least two notches formed in one or both flanges for securing cord portions.

### BRIEF DESCRIPTION OF THE DRAWINGS

FIG. 1 is a perspective view of a device according to a first embodiment of the present invention.

FIG. 2 is a top view of the first embodiment of the present invention.

FIG. 3 is a front view of the first embodiment of the present invention.

FIG. 4 is a first side view of the first embodiment of the present invention.

FIG. 5 is a second side view of the first embodiment of the present invention.

FIG. 6 is a top view as in FIG. 2 showing a cord being retained therein.

### DETAILED DESCRIPTION OF THE PREFERRED EMBODIMENT OF THE INVENTION

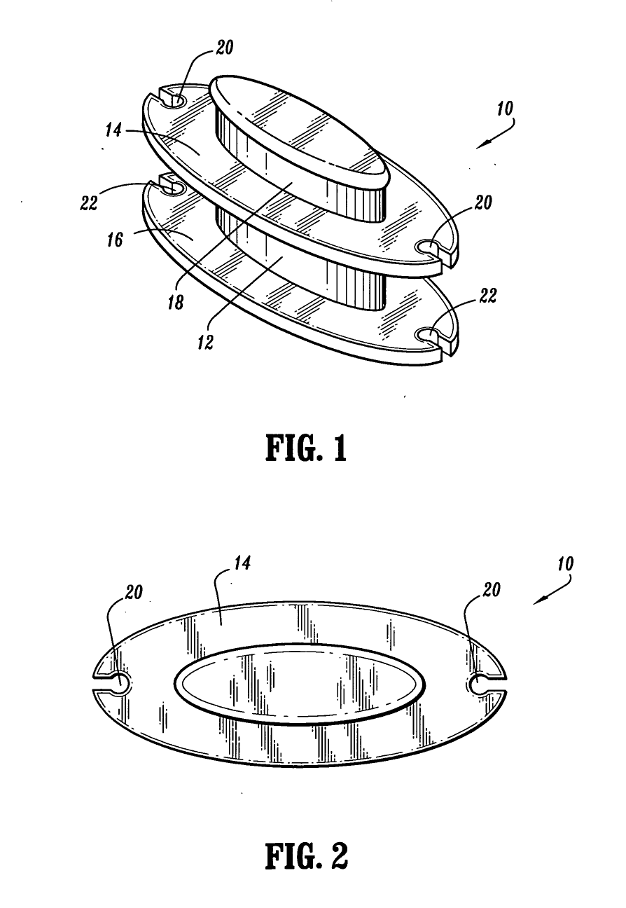

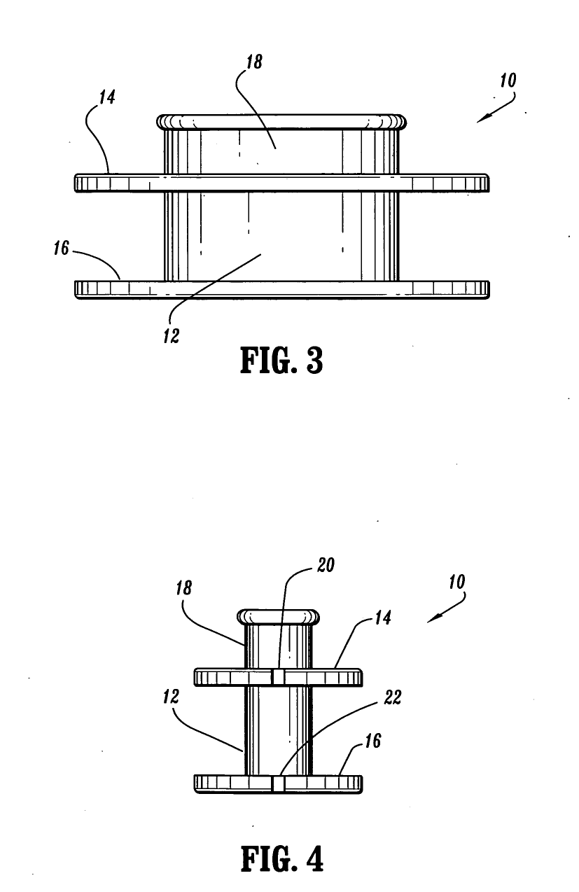

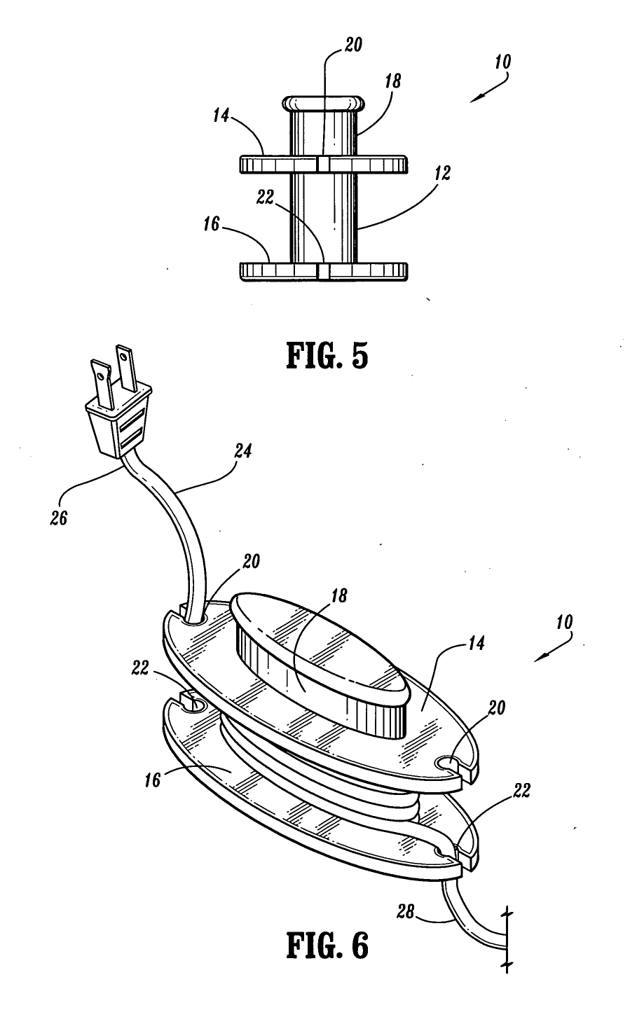

Referring to FIGS. 1-5, a retaining device (10) according to a preferred embodiment of the present invention has a core (12), a first flange (14), a second flange (16), a core handle extension (18), a pair of first notches (20), and a pair of second notches (22). The device (10) may be made of a unitary piece of molded plastic or any sufficiently rigid material, or it may be assembled from components fixed to each other. The device (10) is designed and sized so that a cord (24) or cord-like article, such as an electrical power cord, is wound around the core (12) and its extending ends (26, 28) are directed away from the core (12) and each end (26, 28) is retained in a notch (20), as shown in FIG. 6. A user may grasp the device (10) by holding the core handle extension (18) during or after winding or un-winding of the cord (24). Once a cord (24) is wound and retained by the notches (20), as shown in FIG. 6, the device (10) may be rested on a surface of it may be suspended by the cord (24) lengths that extend therefrom.

Various modifications may be made to the present invention device as illustrated herein without departing from the scope of the claimed invention. For example, a device according to the present invention may be made with a different cross-sectional shape than that shown (i.e., oval). The cross-sectional shape could be round, square, triangular, irregular and other shapes. A device according to the present invention could be made with another type of cord end retaining means instead of a notch, such as a clamp. A device according to the present invention could be made without a handle extension (18).

1. A device for holding a cord, said device comprising
a core adapted to receive said cord about said core in a winding manner;
a pair of flanges spaced apart and adapted to maintain said cord on a portion of said core between said flanges;
at least one cord retainer for maintaining said cord on said core in a manner to prevent said cord from unwinding from said core; and
a handle portion extending from said core and adapted to be held by a user's hand to enable a user to hold and transport said device.

2. The device according to claim 1, wherein said cord retainer comprises a notch on one of said flange for grasping a portion of said cord.

3. The device according to claim 1, wherein said cord retainer comprises a pair of notches on one of said flanges for grasping two portions of said cord.

4. The device according to claim 1, wherein said cord retainer comprises at least one notch on one of said flanges for grasping a first portion of said cord, and at least one notch on the other of said flanges for grasping a second portion of said cord.

5. (canceled)
